(19) United States
(12) Patent Application Publication
(10) Pub. No.: US 2007/0227367 A1
(43) Pub. Date: Oct. 4, 2007

(54) Food rack

(76) Inventors: Keith E. Antal SR., Valatie, NY (US); Scott Peterson, Cary, IL (US)

Correspondence Address: IP GROUP OF DLA PIPER US LLP, ONE LIBERTY PLACE, 1650 MARKET ST, SUITE 4900, PHILADELPHIA, PA, 19103, US

(21) Appl. No.: 11/392,897

(22) Filed: Mar. 29, 2006

(51) Int. Cl. A47J 43/18

(52) U.S. Cl. 99/426

(57) ABSTRACT

A rack is provided in combination with a tray for handling food products inside of an oven. The tray has a bottom panel and walls extending upwardly from a perimeter of the bottom panel. The rack comprises a generally planar plate and a plurality of aperture clusters extending therethrough. The aperture clusters are sized and shaped to correspond to the food products to be held on the rack. Generally, one aperture cluster corresponds to one food product and is sized to define a surface area that is smaller than that of the food product whereby, when the food product is placed on the top surface of the plate adjacent the aperture cluster, the food product covers the aperture cluster. The rack may also have legs extending away from the bottom surface of the plate.

### FIELD OF THE INVENTION

The invention relates to apparatus for handling food products during cooking, warming and between the time of preparation and service.

### BACKGROUND

Ovens are used in the food service industry to cook food products or keep them warm between the time of preparation and the time of service. These food products may be hamburger patties, vegetable or soy patties, chicken patties, fish patties, or any other product that is generally served warm. A known oven used in a fast food restaurant holds prepared food between the time of preparation and the time of serving. It is preferable that this type of warming oven keep the food in a ready-to-eat state. Temperatures inside the warming oven may reach levels above 180 degrees Fahrenheit. Temperatures in other ovens, such as those for cooking or heating, may be higher than 400 degrees Fahrenheit. It is also desirable to regulate the humidity within the oven to ensure that the food does not become dried out or soggy.

When food products are stored in ovens, there is a tendency for them to exude fluids. These fluids may be the natural juices of foods such as meat, or water that is released as a result of the thawing process.

In some cases, food products are placed on racks or trays inside of the ovens. This allows for organized storage of the food, as well as easy insertion and removal of the food products from the oven. Some trays are made using solid bottom panels with walls extending upwardly around their perimeter, forming a cupped tray. In situations where the food is placed in a tray, the food product may be left to stew in its own fluid or fluid from adjacent products, making the food soggy.

To correct the problems of sogginess that arose as a result of food products becoming soggy while stored in trays, racks may be used to hold the food products while in the oven. Generally the racks are perforated, or constructed from materials such as wire mesh to allow the fluids of the food products to drip through the rack. Known racks have generally homogeneous top surfaces with perforations or mesh covering the entire surface of the rack. In some instances, the racks are used in connection with trays, to allow stacking of racks without having fluids drip from the upper racks to the food products below. When the food product rests on the racks in the ovens, fluid is free to drip from the food products into a collection area, such as a tray. Once in the collection area, because the entire surface of the rack was porous, the fluid may evaporate into the atmosphere inside of the oven. Because ovens have humidity controls, the evaporated fluids are sometimes removed from the oven, thereby leaving the food product to dry out inside of the oven.

It would be beneficial to provide an apparatus for handling food products in an oven that facilitates the drainage of fluids away from the food product while preventing the food product from drying out.

### SUMMARY OF THE INVENTION

This invention relates to apparatus for cooking, heating and keeping food warm between the time of preparation and service. Specifically, the invention relates to a rack for retaining food products in ovens or other environmentally controlled devices.

One aspect of the invention is a rack used in combination with a tray for handling food products inside of an oven. The tray has a bottom panel and walls extending upwardly from a perimeter of the bottom panel. The rack comprises a plate having a plurality of aperture clusters extending therethrough. The aperture clusters define an area sized and shaped to correspond to a food product to be placed thereon, such that one aperture cluster corresponds to one food product. When the food product is placed on the plate, above the aperture cluster, the food product covers the aperture cluster. The rack may also have legs extending away from the bottom of the plate.

A further aspect of the invention includes an apparatus for handling food products in a warming oven comprising a tray and a rack. The tray has a bottom panel and walls extending upwardly from a perimeter of the bottom panel. The walls and the bottom panel form a holding area. The rack has a generally planar plate having an outer edge and plurality of aperture clusters extending therethrough. The aperture clusters are shaped and sized to correspond to a food product to be placed thereon, such that the food product will cover the aperture cluster when disposed on the plate. When the rack is placed inside the tray, the outer edge of the plate is disposed proximate the walls such that the plate spans the holding area thereby, along with the walls and bottom plate, defining a cavity.

### BRIEF DESCRIPTION OF THE DRAWINGS

For the purpose of illustrating the invention, there is shown in the drawings a form that is presently preferred; it being understood, that this invention is not limited to the precise arrangements and instrumentalities shown.

FIG. 1 is a perspective view of a rack according to an embodiment of the present invention.

FIG. 2 is a perspective view of the bottom portion of the rack of FIG. 1.

FIG. 3 is a side elevational view of the rack of FIG. 1.

FIG. 4 is a perspective bottom view of a rack according to an alternative embodiment of the present invention.

FIG. 5 is a perspective view of the rack of FIG. 1, shown in connection with a tray and food products.

FIG. 6 is a cross-sectional view of the rack of FIG. 5, taken along the line 6-6, shown disposed inside of an oven chamber.

### DETAILED DESCRIPTION OF THE DRAWINGS

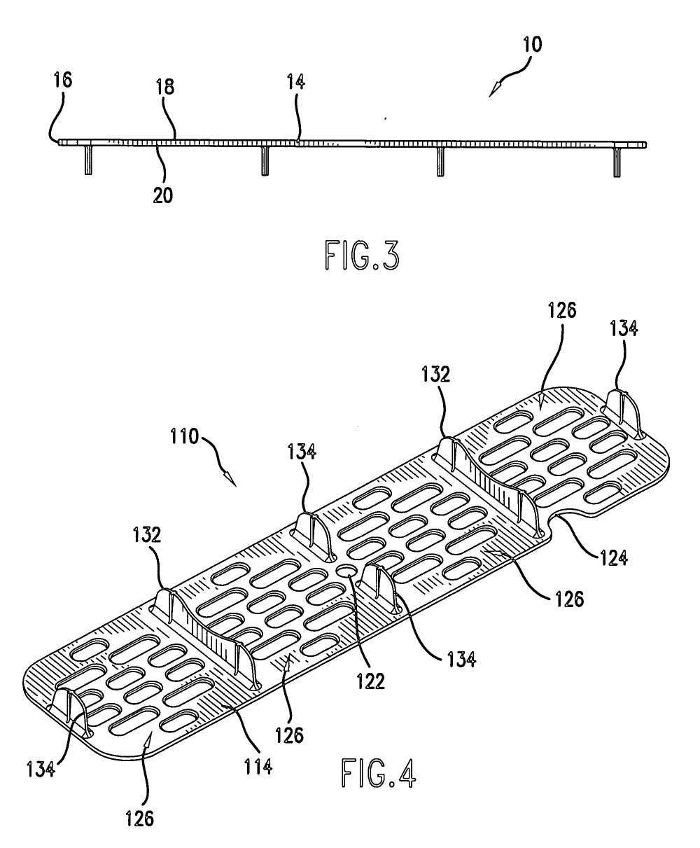

In the figures, where like reference numerals indicate like elements, there is shown an embodiment of a rack, which is identified generally by the numeral 10, for handling food products disposed in ovens 11, such as those commonly used in fast food restaurants. The rack 10 is generally used in connection with a tray 12 when disposed in the oven 11. For purposes of this disclosure, the directions up and down, and correspondingly top and bottom, will refer to those directions when viewed in FIG. 3.

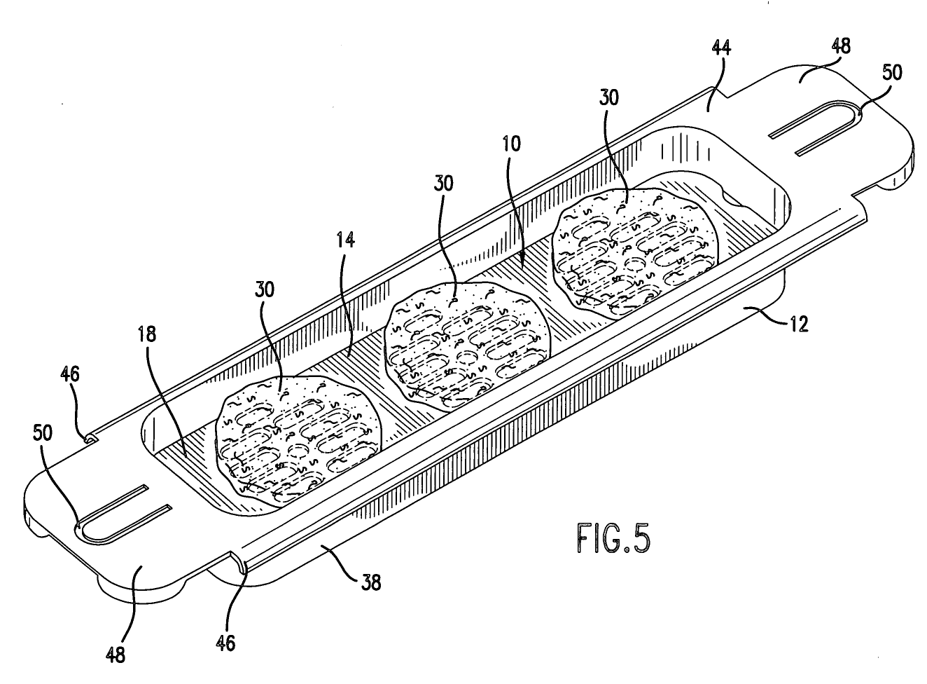

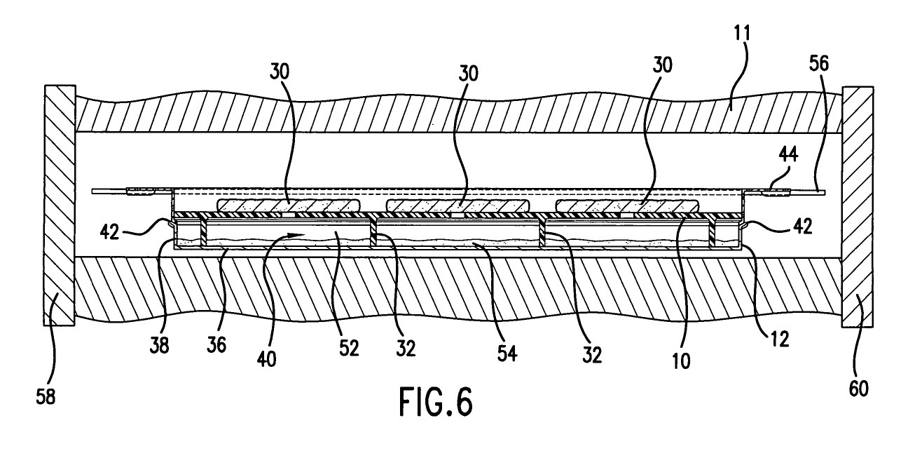

The rack 10, as illustrated, has a generally planar plate 14 having an outer edge 16, extending around a perimeter thereof, a top surface 18 and a bottom surface 20. The depth of the outer edge 16 is preferably equal to the thickness of the plate 14, as best seen in FIG. 3. The plate 14 has a generally rectangular shape and rounded corners 22. A recess 24 may be provided along a portion of the outer edge 16 of the plate 14. A plurality of aperture clusters 26 are disposed on the plate 14, with each aperture 28 extending from the top surface 18, through the plate 14, to the bottom surface 20. Each aperture cluster 26 may contain multiple apertures 28 of various shapes and sizes, such as circular, oval, rectangular or any other suitable shape. The aperture clusters 26 are sized to correspond to food products 30 that are placed on the rack 14. In the embodiments shown in the drawings, the aperture clusters 26 are generally round and adapted to correspond to generally round food products 30, such as those shown in FIGS. 5 and 6, however, those skilled in the art will recognize that the aperture clusters 26 may be any shape and size, so long as they correspond to the food product that they are used with. The aperture clusters 26 are sized to be slightly smaller than the food product 30 so that when the food product 30 is disposed on the rack 14, each aperture cluster 26 is covered by a food product 30.

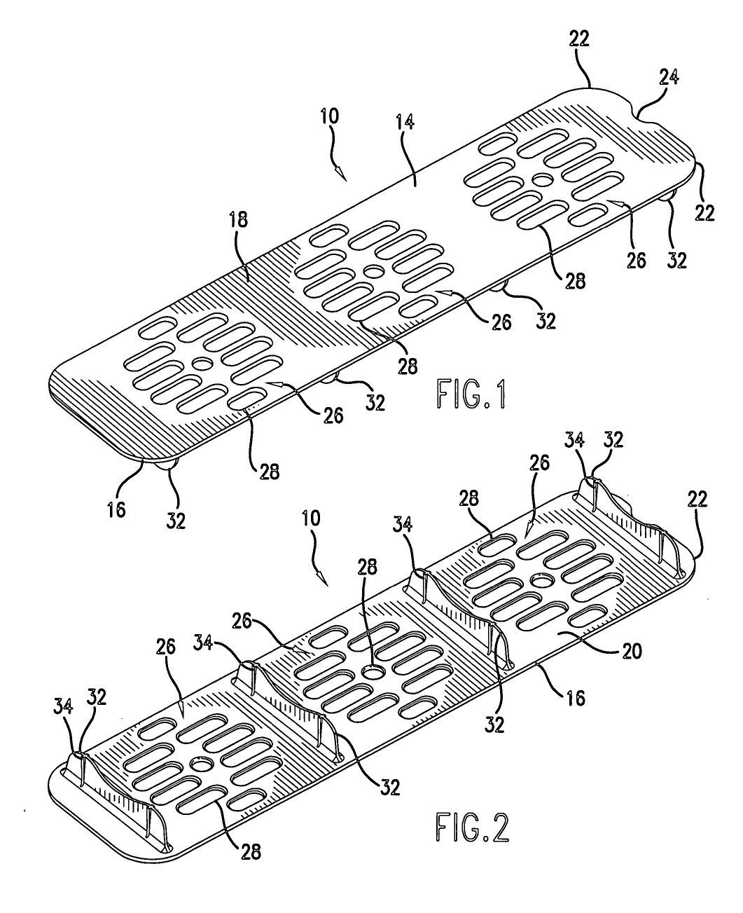

A plurality of legs 32 extend from a bottom surface 20 of the plate 14. The legs 32 are generally perpendicular to the plate 14 and disposed between aperture clusters 26, as best seen in FIG. 2. The legs 32 may have braces 34 to strengthen the leg 32 and minimize deflection. The legs 32 may extend the width of the rack 10, as seen in FIG. 2, or, alternatively, legs 32 may be disposed on either side, or in the center of, the rack 10, as shown in FIG. 4. Alternatively, the rack 10 may have no legs.

An alternative embodiment of a rack 110 is shown in FIG. 4. The rack 110 is similar to the rack 10 in that it is constructed from a generally planar plate 114 having legs 132, 134 extending perpendicularly from its bottom surface 120. The rack 110 has a plurality of aperture clusters 126 that, like the aperture clusters 26, are generally round. Unlike the rack 10, the rack 110 has four aperture clusters 126 and a recess 124 disposed along a lateral side of the rack 110, rather than at a longitudinal end. The rack 110 also has a vent hole 122, located in the center of the plate 140. Finally, while some legs 132 of the rack 110 extend across the width of the plate 120, there are some legs 134 that are not as wide as the plate 114.

The tray 12, used in connection with the rack 10, has a bottom panel 36 and walls 38 extending upwardly therefrom. The walls 38 are generally perpendicular to the bottom panel 36 and, together with the bottom panel 36, define a holding area 40 for the rack 10 and the food product 30. A ridge 42 extends around the inner face of the walls 38. Preferably, the ridge 42 lies in a plane that is generally parallel to the bottom panel 38. The ridge 42 is preferably raised sufficiently above the bottom panel 36 to allow fluids to accumulate in the bottom of the tray 12 without reaching the level of the ridge 42.

A rim 44 extends around upper portions of the walls 38 and defines the top of the tray 12. The rim 44 preferably has mounting projections 46 extending longitudinally along the lateral sides of the tray 12. The mounting projections 46 preferably have a generally arcuate cross-sectional profile and extend outwardly and downwardly from the rim 44. Longitudinal ends of the tray 12 have gripping extensions 48 that facilitate handling of the tray 12. The gripping extensions 48 may have notches 50 to facilitate the engagement of locking tabs (not shown) within the oven 11. The locking tabs may click into the notches 50 to indicate to the user that the tray 12 is correctly positioned within the oven 11.

The rack 10 is sized and shaped to fit snugly within the tray 12. When the rack 10 is inserted in the tray 12, the legs 32 preferably rest on the bottom panel 36. The outer edge 16 of the plate 14 is adapted to fit snugly within the walls 38. It is preferable that there is a very small, if any, amount of space between the outer edge 16 and the walls 38. The recess 24 is adapted to provide sufficient space for a user to remove the rack 10 from the tray 12, using a finger or some type of tool (not shown). In an embodiment where the rack 10 has no legs, the rack 10 preferably rests on the ridge 42. Regardless of whether or not the rack 10 has legs 32, it is preferable that the fit between the rack 10 and the tray 12 restricts the escape of any fluids that accumulate in the bottom of the tray 12.

A cavity 52 is formed below the plate 14, within the tray 12. The cavity 52 is defined by interior surfaces of the bottom panel 36 and walls 38 of the tray 14, as well as the bottom surface 20 of the plate 14. The cavity 52 is further defined by the food product 30 placed on the rack 10. As best seen in FIGS. 5 and 6, the food products 30 cover the aperture clusters 26, thereby substantially sealing the cavity 52. The recesses 24, 124 and the vent hole 122 present small openings between the cavity 52 and the atmosphere of the oven 11. This may provide for a small amount of evaporation of the fluids 54, out of the cavity 52, but the total cross-sectional area of any such openings is small compared to that of the apertures 32. Therefore much of the evaporated fluid 54 will end up returning to the food product 30, keeping the food product 30 moist.

In use, the rack 10 is placed inside of the tray 12, with food products 30 placed on top of the rack 10, covering the aperture clusters 26. The assembly is placed in an oven 11 to cook or keep the food products 30 at a desired temperature. In the embodiment shown here, the mounting projections 46 are preferably slid onto a mounting rail 56. Preferably, the mounting rails 56 are adapted to keep the rack 20 level and suspended within the oven 11. Also, because the mounting projections 46 and rails 56 are on lateral sides of the tray 12, the tray 12 can be inserted and removed from the oven 11 through multiple doors 58, 60 located on opposing ends of the oven 11.

As the food products 30 are heated, they tend to exude fluid 54. When the food products 30 are placed on the rack 10, above the aperture clusters 26, the fluid 54 drains through the apertures 28, into the cavity 52. The legs 32 are sufficiently long enough, or the ridge 42 is sufficiently high enough, to keep the food products 30 from resting in the fluid 54. Regardless of the shape of the apertures 28, or the aperture clusters 26, it is preferable that the plate 14 provide sufficient support for the food products 30 while providing a generous area of apertures 28 to facilitate the draining of the fluids into the cavity 52. It is preferable that more lateral surface area of food product 30 is disposed over the aperture clusters 26 than is disposed over the top surface 18 of the plate 14.

Because the aperture clusters 26 are sized and shaped to be covered by the food product 30, the fluid 54 that drains into the cavity 52 is restricted from evaporating into the air above the rack 10. Rather, any fluid 54 that evaporates from the cavity 52 returns to the food product 30, thereby serving to keep the food product 30 moist, while preventing it from becoming soggy.

The balance between sogginess and dryness is a result of the sizing and shaping of the aperture clusters 30 in the rack 10, which allow fluid to drain from the food product 30, while supporting the food product 30 above the collection area of the fluid 54. Regarding dryness, the aperture clusters 26 facilitate the evaporation of the fluid 54 back into the food product 30, rather than into the atmosphere in the oven 11. Because most, if not all, of the apertures 28 in the rack 10 are covered by the food product 30, there is substantially less evaporation of the fluid 54 into the atmosphere of the oven 11 than occurs with a rack having a plate that is perforated across its entire surface.

The rack 10 and tray 12 may be constructed using a variety of materials such as plastics, metals, composites and ceramics. The desired material may depend on the use of the rack 10 and tray 12, which may also may vary. By way of example, the rack 10 may be used in an oven for cooking food products, warming cooked food products or keeping warm food products at a desirable temperature prior to serving.

A variety of modifications to the embodiments described will be apparent to those skilled in the art from the disclosure provided herein. Thus, the invention may be embodied in other specific forms without departing from the spirit or essential attributes thereof and, accordingly, reference should be made to the appended claims, rather than to the foregoing specification, as indicating the scope of the invention.

What is claimed is:

1. A rack used in combination with a tray for handling food products inside of an oven, the tray having a bottom panel and walls extending upwardly from a perimeter of the bottom panel, the rack comprising:
a generally planar plate having plurality of aperture clusters extending therethrough, aperture clusters defining an area sized and shaped to correspond to the surface area of a food product, such that one aperture cluster corresponds to one food product, whereby, when the food product is placed on the plate, above the aperture cluster, the food product covers the aperture cluster.

2. The rack according to claim 1, wherein the plate is sized for cooperative engagement with the walls and the bottom panel of the tray, whereby the rack is adapted to rest inside of the tray at a predetermined height above the bottom panel.

3. The rack according to claim 2, wherein a cavity is defined by the walls, the bottom panel of the tray and the plate, and the food product is placed on the aperture clusters to close the cavity.

4. The rack according to claim 1, wherein the plate is generally rectangular.

5. The rack according to claim 1, wherein the aperture clusters are arranged longitudinally along the plate.

6. The rack according to claim 1, further comprising at least one leg adapted to support the rack within the tray.

7. The rack according to claim 1, wherein the plate is adapted to rest on an internal ridge disposed along an inner surface of the wall, when the rack is inserted into the tray.

8. An apparatus for handling food products in an oven comprising:
a tray having a bottom panel and walls extending upwardly from a perimeter of the bottom panel, the walls and the bottom panel forming a holding area; and
a rack defined by a generally planar plate having a plurality of aperture clusters extending therethrough and edges extending around a perimeter thereof, wherein the aperture clusters are shaped and sized to correspond to a food product to be placed thereon, such that the food product will cover the aperture clusters when disposed thereon;
the plate sized such that, when disposed in the holding area, the edges are positioned proximate the walls such that the plate spans the holding area and forms a defined cavity with the walls and the bottom panel.

9. The apparatus according to claim 8, wherein legs are provided on the bottom of the plate and engage the bottom panel when the rack is disposed inside the holding area.

10. The apparatus according to claim 8, wherein the aperture clusters are aligned longitudinally along the plate.

11. The apparatus according to claim 10, the rack further comprising a plurality of legs extending therefrom.

12. The apparatus according to claim 8, the tray further comprising a ridge disposed on an inner surface of the wall, wherein the rack is adapted to be disposed on the ridge when inserted into the tray.
